(19) United States
(12) Patent Application Publication
(10) Pub. No.: US 2018/0285932 A1
(43) Pub. Date: Oct. 4, 2018

(54) METHOD TO MATCH VIDEO AD DURATION TO VIDEO CONTENT DURATION

(71) Applicant: Google Inc., Mountain View, CA (US)

(72) Inventors: Sofia Andrianakou, Mountain View, CA (US); Yuanying Xie, Sunnyvale, CA (US)

(73) Assignee: Google Inc., Mountain View, CA (US)

(21) Appl. No.: 14/231,114

(22) Filed: Mar. 31, 2014

(51) Int. Cl. G06Q 30/02

(52) U.S. Cl. CPC G06Q 30/0269

(57) ABSTRACT

In a method and system for matching advertisement duration to content duration, a user request for a content item is received, a content duration of the content item is identified, and at least one advertisement that has a duration commensurate with the duration of the content item is obtained. The advertisement is provided along with the content item for presentation to the user.

### TECHNICAL FIELD

Aspects of the present disclosure relate to the field of content sharing and, more particularly, to a method for matching advertisements to content.

### BACKGROUND

On the Internet, content hosting websites or other applications allow users to upload, view, and share digital content. Such digital content may include audio clips, movie clips, TV clips, and music videos, as well as amateur content such as video blogging, short original videos, pictures, photos, etc.

As a way of generating revenue, advertisements can be associated with the content, such that a viewer of the content has the option to view the advertisements upon selecting to view the content or is required to view the advertisements to view the content. Ad providers (e.g., organizations or individuals) can pay a fee to a content publisher to have certain advertisements associated with certain content with the hope that a viewer of the advertisement and the content will be persuaded to purchase the advertised good or services, or otherwise respond in a certain way to the advertisement. However, the viewer may determine that viewing the advertisements is not worth the time commitment when the length of the advertisements is compared with the length of the content. As a result, the viewer may choose to skip the advertisement, if viewing the advertisement is optional, or choose to not view the content, if viewing the advertisement is not optional.

If the viewer does not view the advertisement, the content publisher may not receive the advertising fee, and the ad provider loses this opportunity to persuade the viewer to respond in a certain way to the advertisement.

### SUMMARY

In some implementations, a method to match advertisement duration to content duration is presented. The method includes receiving a user request for content. A content duration of the content item is identified, and at least one advertisement that has a duration commensurate with the duration of the content item is obtained. The advertisement is provided along with the content item for presentation to the user.

In some implementations, at least one advertisement can include a plurality of advertisements, and a combined duration of the plurality of advertisements is commensurate with the duration of the content item. The content duration can be identified based on metadata associated with the content.

In some implementations, obtaining the advertisement can further include sending an advertisement request for the content item to an advertisement management server, the advertisement request including characteristics of the content item. A plurality of advertisements corresponding to the characteristics of the content item can be received from the advertisement management server, and the advertisement can be selected based on a duration correspondence criterion.

The duration correspondence criterion can be defined by an owner of the content item or a content sharing service. The duration correspondence criterion can require that the duration of the advertisement be no longer than the duration of the content item or that the duration of the advertisement be a fraction of the duration of the content item.

In some implementations, obtaining the advertisement can further include sending an advertisement request for the content item to an advertisement management server, the advertisement request including characteristics of the content item and the duration of the content item, and receiving, from the advertisement management server, the advertisement satisfying a duration correspondence criterion. The duration correspondence criterion can be defined by an advertiser associated with the advertisement, and the advertisement satisfying the duration correspondence criterion can be selected at the advertisement management server.

In some implementations, a method includes receiving, by an advertisement management server, an advertisement request for a content item from a content sharing server. The method can also include identifying, based on the advertisement request, characteristics of the content item and a duration of the content item, and selecting, from a data store, one or more advertisements that correspond to the characteristics of the content item and have a duration commensurate with the duration of the content item. The method can further include providing, to the content sharing server, the selected advertisements for targeting the content item.

### BRIEF DESCRIPTION OF THE DRAWINGS

The present disclosure will be understood more fully from the detailed description given below and from the accompanying drawings of various embodiments of the disclosure.

FIG. 1 illustrates exemplary system architecture, in accordance with one embodiment of the present disclosure.

FIG. 2 illustrates an advertisement correspondence system, in accordance with one embodiment of the present disclosure.

FIG. 3 is a flow diagram illustrating one embodiment for a method of matching advertisement duration to content duration.

FIG. 4A is a flow diagram illustrating one embodiment for a method of obtaining one or more advertisements for a content item.

FIG. 4B is a flow diagram illustrating one embodiment for a method of providing one or more advertisements for a content item.

FIG. 5 is a block diagram of an exemplary computer system that may perform one or more of the operations described herein.

### DETAILED DESCRIPTION

Aspects of the disclosure pertain to matching advertisement duration to content duration. For example, a viewer (or user) may desire to play content, such as video content, that is available for view on a content sharing server (e.g., a social network application, a network television application, or a content posting service), and may select to have this content played. In addition to serving the selected content, the content sharing server can also serve one or more advertisement with the content. For example, an advertiser may be willing to pay a fee, e.g., to the content sharing server and/or a creator of the content, to have the advertisement played in association with the content so the advertiser can get a message across to the viewer of the content. In an embodiment, an advertisement duration can be selected such that an advertisement is a suitable length when viewed prior to or during a break in content, when the length of the content is considered. Because the duration of the advertisement is appropriate to (or commensurate with) the duration of the content, a viewer is more likely to view the advertisement, rather than skipping the advertisement or skipping the advertisement and the content.

Content sharing servers that do not take into account the duration of content (e.g., a user selected video) when selecting advertisements to serve with the content could deliver advertisements with a duration that is unsuitably long when the length of the content is considered. For example, a user may be served a pre-roll advertisement (e.g., an advertisement that plays prior to the play of the content) that is two minutes long before being served a 30 second video. The user may be able to determine the length of the advertisement based on visual cues associated with the advertisement.

If the user is allowed to skip the advertisement to immediately play the content, the user is more likely to skip the advertisement because the advertisement is so much longer than the content that the user actually desires to see. If the user is required to view the advertisement prior to the content being played, the user is more likely to skip both the advertisement and the content, because the user is less likely to find the content to be worth the long wait that the user must endure while the advertisement plays. In either situation, if the user does not view the advertisement, the advertisement fee may not be paid to a content publisher and/or a content creator, and the advertiser loses the opportunity to get the advertiser's message across. The user may decide to watch part of the advertisement (e.g., enough of the advertisement that the advertiser is charged a fee), but then get frustrated with the length and skip the remainder of the advertisement. Here, the advertiser is charged the fee, but does not get to deliver the entire message to the user. Also, a content provider may not want the advertisement length to hamper the user's consumption of content of the content provider, so the content provider benefits if the user has a positive experience

According to an embodiment, a duration correspondence criterion can be used that, e.g., indicates an advertisement duration that should have a correspondence with (or be proportional to) a certain content duration. In an example, advertisements that have a duration longer than 30 seconds are not paired (or associated) with content that has a duration of 30 seconds. In another example, advertisements that have a duration greater than 60 seconds are only associated with content that has a duration greater than 2 minutes. In another example, advertisements are associated with content where the advertisement duration is equal to or less than the content duration. In another example, a content provider may have special content (e.g., a breaking news story) where users would be willing to watch advertisements that are not necessarily commensurate with the length of the content due to the special nature of the content, and the duration correspondence criterion can be selected accordingly to indicate that relatively longer advertisements can be paired with the special content. The duration correspondence criterion can be provided by the advertiser or the content sharing service, according to an embodiment.

In an embodiment, the duration of the content selected by the user can be determined, e.g., via metadata associated with the content. Once the content duration is determined, an advertisement duration can be determined, e.g., based on the content duration and/or a duration correspondence criterion. A matching advertisement is determined based on the determined advertisement duration. The advertisement and the content can then be played for the user.

In an embodiment, a group of multiple advertisements can be matched with the content, where the duration of the group corresponds to the duration of the content.

Aspects of embodiments allow advertisers and/or content creators/providers to better match advertisements to content and improve the advertisement experience for users, such that the users have a more reasonable and enjoyable experience. Further, because advertisements are less likely to be skipped, advertisement revenue of content creators/providers from advertisement fees can be increased and advertisers are more likely to have a better return on investment for their advertising money.

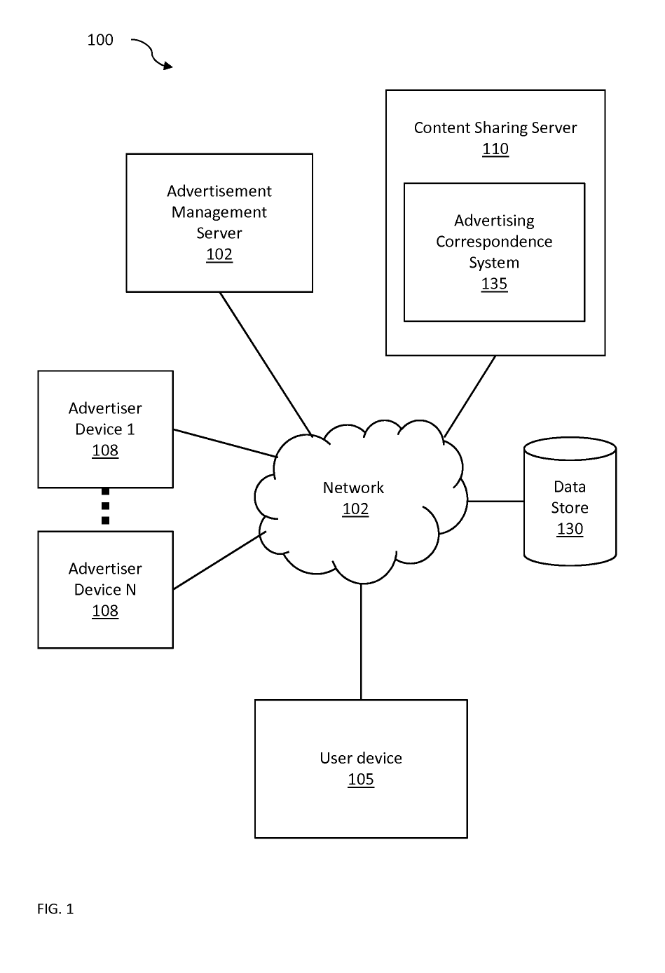

FIG. 1 illustrates exemplary system architecture 100, in accordance with one embodiment of the present disclosure. System 100 comprises a user device 105, a content sharing server 110, a data store 130, an advertisement management server, and advertiser devices 1 to N in communication with (e.g., coupled to) each other over a network 102. The network 102 may be a private network (e.g., a local area network (LAN), a wide area network (WAN), intranet, etc.), a corporate network (e.g., a private network for an organization such as a corporation), a broadcast network, a public network (e.g., the Internet), a wired network (e.g., Ethernet network), a wireless network (e.g., an 802.11 network) and/or a cellular network (e.g., a Long Term Evolution (LTE) network).

The user device 105 may be any type of computing device, for example, a device including a processor, a computer-readable medium, and a memory. In some embodiments, the user device 105 may be executing a browser application or other application adapted to communicate over Internet related protocols (e.g., TCP/IP and HTTP) and/or display a user interface. While only a single user device 105 is shown in FIG. 1, system 100 may support a large number of concurrent sessions with many client/user devices.

The content sharing server 110 may include computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Embodiments of the disclosure may operate within a single server device or on multiple server devices.

In one embodiment, the content sharing server 110 provides media or content items (e.g., digital video, streaming video, images, digital music, streaming music, social media information, etc.) to one or more user devices 105. For example, the content sharing server 110 may be part of a content sharing platform and may provide a media item, such as a streaming video, requested from an activity feed by a user for playback on the user device 105 via the network 102. The content sharing server 110 may represent a video hosting website, a news content provider, a social network site, or any other entity that provides media content (e.g., video or audio content) to the user devices 105.

Data store 130 can store media content or links to media content and can include one or more writable persistent storage devices, such as memories, tapes or disks. Although each of content sharing server 110 and data store 130 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices.

During operation of system 100, a user requests a content item (e.g., a video, a video clip, or other video content) via user device 105 over network 102. The content sharing server 110 receives communications from the user device 105, and processes and/or directs these communications accordingly. In an embodiment, the user device 105 makes a request to the content sharing server 110. For example, the user device 105 can make a request to view a content item (e.g., to download or stream a video) from the content sharing server 110. The content sharing server 110 receives and responds to the request by providing the requested content item with one or more advertisements targeting the requested content item.

In some implementations, the content sharing server 110 can determine what advertisement(s) to provide with the requested content item using the advertisement management server 102. The advertisement management server 102 can be an independent system and can include one or more computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Alternatively, the advertisement management server 102 can be hosted by the same machine(s) as the content sharing server 102.

In some implementations, advertisers can access the advertisement management server 102 via advertiser devices 108 to enter, maintain and track advertisement information. The advertisement management server 102 may provide a list of available advertisement placements and corresponding prices for the available placements to the advertisers. A placement may refer to any web or user interface (UI) property that can enable the presentation of advertisements. A web or UI property can represent, for example, a search result UI, a watch page UI, a website, a subset of web pages, or any other network distributed content, etc. An advertiser can specify one or more targeting criteria (e.g., type of content, type of UI, etc.) to select placements on which the advertiser would like to place the ads. The advertisement management server 102 may then store the associations between the selected placements and the corresponding ads. The ads may include graphical ads (e.g., banner ads), text only ads, image ads, audio ads, video ads, etc. The ads may also include embedded information, such as a link, meta-information, and/or machine executable instructions.

The content sharing server 110 can include an advertisement correspondence system 135. The advertisement correspondence system 135 determines a duration of the requested content item. For example, the advertisement correspondence system 135 can determine a duration of the content item via metadata associated with the content item or via any other suitable means. In some implementations, once the advertisement duration has been determined, then the advertisement matching system 135 can obtain an advertisement with a duration corresponding to the duration of the requested content item. For example, if the content duration is two minutes, then an advertisement that is not longer than two minutes can be obtained, such as Advertisement A with a duration of one minute and 45 seconds.

Once the advertisement has been obtained, the content sharing server 110 can provide the advertisement and the content item to the user device 105 for display on the user device. In an embodiment, at least a portion of the advertisement is displayed before the user is allowed to skip the advertisement to view the content. Further, an advertisement duration and/or a content duration may be displayed, such that the user knows how much time will pass before display of the advertisement ends and display of the content item begins. Since the advertisement duration has been matched to the content duration, the user may be more willing to view the entire advertisement rather than skipping the advertisement.

In another embodiment, the entire advertisement is displayed prior to the content item being displayed. Here, an advertisement duration and/or a content duration may be displayed such that the user knows how much time will pass before display of the advertisement ends and display of the content begins. Since the advertisement duration has been matched to the content duration, the user may be more willing to view the advertisement and wait for the content item to begin, rather than deciding that the ability to view the content item is not worth waiting through the advertisement and moving on to another activity.

The content sharing server 110 can obtained advertisements using the advertisement management server 102. In some implementations, the content sharing server 110 may submit an advertisement request to the advertisement management server 102 upon receiving a content item request from the user device 105. The advertisement request submitted by the content sharing server 110 may include content item request information such an identifier of the requested content item, a category corresponding to the requested content item (e.g., business, movies, music, etc.), content item type (e.g., video, audio, etc.), content item age, geo-location information, etc.

Upon receiving an advertisement request from the content providing system 110, the advertisement management server 102 may select one or more ads matching the content item request information, and provide the selected ads to the content sharing server 110.

In one implementation, the ads selected by the advertisement management server 102 are auctioned to determine what ads should be returned to the content sharing server 110 and/or the order in which they should be presented to the user. This determination may depend on, for example, other advertisers' bids (e.g., the maximum amount an advertiser will pay per user click on an advertisement) and/or the performance scores of the ads. The performance score of an ad may be calculated based on, for example, historical click-through rates, relevance of an advertiser's ad text and keywords, an advertiser's account history, etc. In another implementation, the ads are selected by the advertisement management server 102 on a reservation basis (e.g., based on predefined conditions) without taking into account other advertisers' bids and/or the performance scores of the ads.

In some implementations, the content sharing server 110 ensures that one or more ads targeting the requested content item are commensurate in duration with the requested content item. In particular, the content sharing server 110 can receive ads (e.g., ad URLs such as canonical URLs) from the advertisement management server 102 and select one or more ads that are commensurate in duration with the requested content item (e.g., using an ad duration contained in metadata of each ad or provided as part of the canonical URL). The selection can be based on a duration correspondence criterion that can be defined by a content owner, content creator, an end user, etc. Alternatively, a duration correspondence criterion can be set automatically (without any user input) by the content sharing server 110.

In other implementations, the advertisement management server 102 ensures that one or more ads targeting the requested content item are commensurate in duration with the requested content item. In particular, the content sharing server 110 can send to the advertisement management server 102 an advertisement request that includes the duration of the requested content item, as well as characteristics of the requested content item as discussed above. The advertisement management server 102 can then select one or more ads that match the received content characteristics and are commensurate in duration with the requested content item. The ad duration can be based on a duration correspondence criterion that can be defined by an advertiser or set automatically (without any user input) by the advertisement management server 102. The advertisement management server 102 can then provide the selected ad(s) that are commensurate in duration with the requested content item to the content sharing server 110. The duration correspondence criterion that can be defined by the content sharing server 110 and send to the content sharing server 110 with the advertisement request.

In situations in which the systems discussed herein collect personal information about users, or may make use of personal information, the users may be provided with an opportunity to control whether the content sharing platform 110 collects user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the content sharing platform 110.

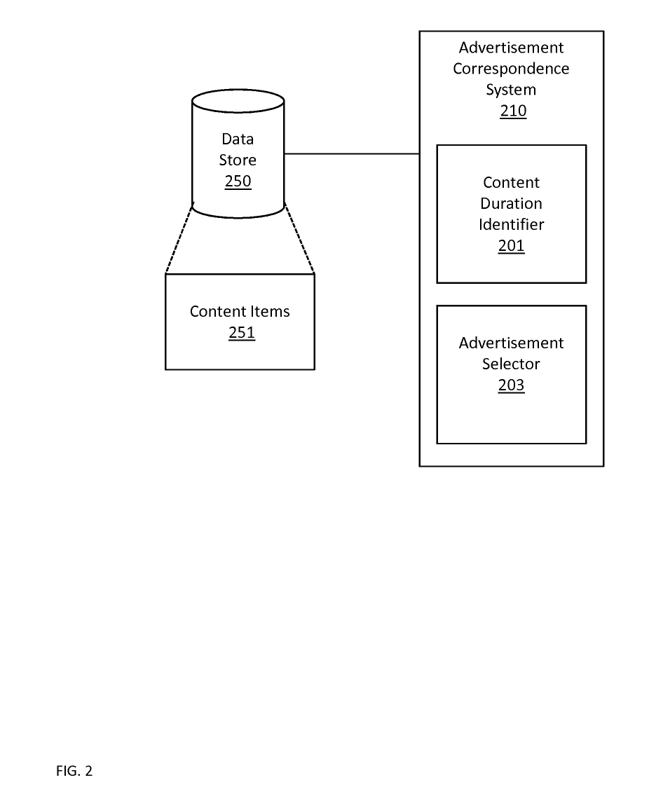

FIG. 2 illustrates an advertisement correspondence system 210, in accordance with an embodiment of the present disclosure. The advertisement correspondence system 210 may include a content duration identifier 201 and an advertisement selector 203. More or less components may be included in the advertisement correspondence system 210 without loss of generality. In an embodiment, advertisement correspondence system 210 is advertisement correspondence system 135 and data store 250 is data store 130 shown in FIG. 1.

In an embodiment, the content duration identifier 201 receives an indication of a request from a user device for a particular content item stored with content items 251 in a data store 250 (i.e., particular content, such as a video). The content duration identifier 201 then determines a content duration of the content item. For example, the content duration identifier 201 can determine for how long the content item would play on the user device. The content duration identifier 201 can determine the content duration in any suitable manner. For example, the content duration may be associated with the content item, such as in associated metadata, along with other characteristics of the content item in the data store 250.

Once the content duration identifier 201 has determined a content duration of the requested content item, the advertisement selector 203 obtains at least one advertisement that has an advertisement duration commensurate with the content duration. In an embodiment, the advertisement selector 203 requests at least one advertisement from an advertisement management server (e.g., advertisement management server 102 of FIG. 1). The advertisement request can include information regarding suitable advertisement durations for particular content durations. For example, the advertisement request can include information that advertisement duration is not to exceed content duration, advertisement duration is not to exceed half of the content duration, or particular advertisement durations are to be selected for particular content durations. In one example, for content durations of less than two minutes, advertisement durations should be no greater than 30 seconds. In another example, for content durations of between five minutes and ten minutes, advertisement durations should be between 60 seconds and two minutes. In another embodiment, the information regarding suitable advertisement durations can reside at the advertisement management server.

Once an advertisement has been selected, the advertisement can be provided along with the content item for presentation to the user. For example, if the duration of the content item is 30 seconds, then it will be presented with an advertisement that has a 30 second duration. In another example, if the duration of the content item is 30 seconds, then it will be presented with an advertisement that has a duration between 15 seconds and 30 seconds in length.

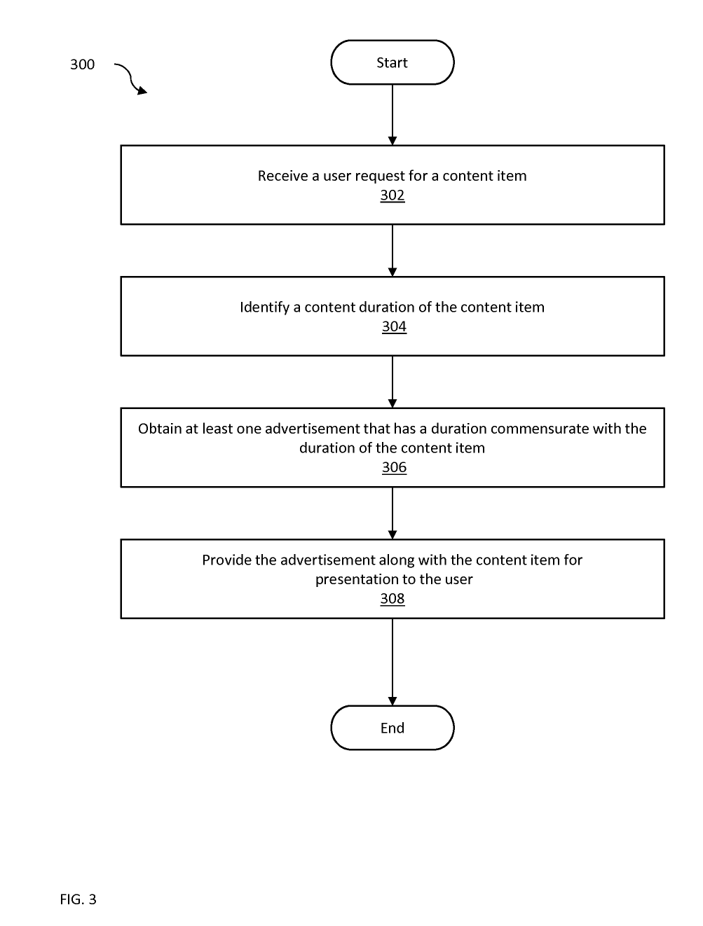

FIG. 3 is a flow diagram illustrating an embodiment for a method 300 of matching advertisement duration to content duration. The method 300 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 300 is performed by a server (e.g., the content sharing server 110 of FIG. 1).

At block 302, processing logic receives a user request for content. For example, a user sends a request to a content sharing server via a user device for the content sharing server to make particular content, e.g., Content A, available for the user to play or view.

At block 304, processing logic determines that the content is allowed to be monetized (allowed to be presented with ads) and identifies a content duration of the content. A duration of the content can be determined via metadata associated with the content, according to an embodiment. Further to the example above, a content duration of Content A can be determined from Content A's metadata to be two minutes.

At block 306, processing logic obtains at least one advertisement that has a duration commensurate with the duration of the content item. According to an embodiment, a duration correspondence criterion can be used to determine the advertisement duration of the advertisement based on the content duration. Further to the example above, a duration correspondence criterion could indicate that advertisement duration of the advertisement cannot be greater than half of the content duration. Since the content duration of Content A is two minutes, the advertisement duration of the advertisement cannot be longer than one minute.

According to an embodiment, an advertisement is selected that has a duration that is the same as the advertising duration. According to another embodiment, an advertisement is selected that has a duration that is in a range defined by the advertising duration. In an example, the advertising duration is a range, where the range is between zero and one minute. Advertisement 1 has a duration of 45 seconds, so the duration of Advertisement 1 is within the range defined by the advertising duration. Therefore, Advertisement 1 can be selected.

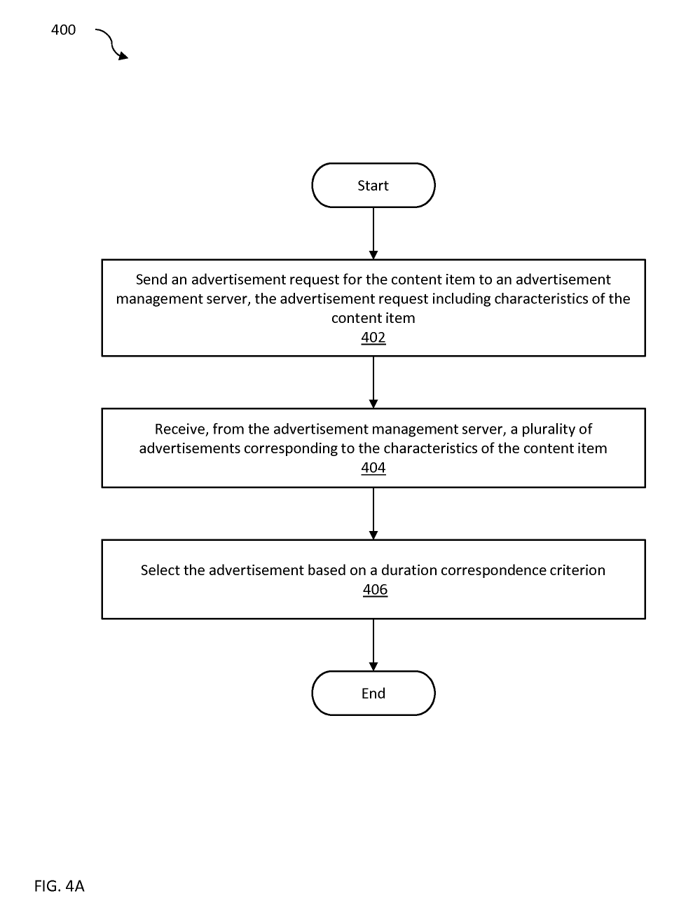

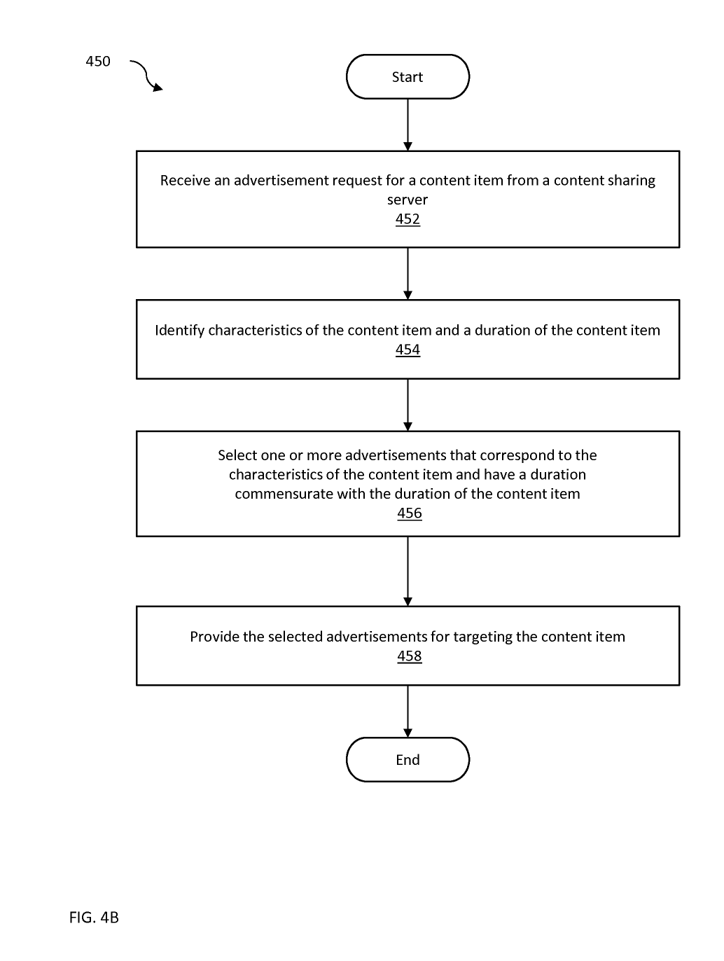

According to an embodiment, an advertisement with a duration commensurate with the duration of the content item can be selected by the content sharing server, as discussed in greater detail below in conjunction with FIG. 4A. In another embodiment, the content sharing server can request that an advertisement management server provide one or more advertisements with a duration commensurate with the duration of the content item (e.g., by providing the duration of the content item and a duration correspondence criterion to the advertisement management server). In yet another embodiment, the advertising management server can select an advertisement that has a duration commensurate with the duration of the content item to be presented with the content item, as discussed in greater detail below in conjunction with FIG. 4B.

At block 308, processing logic provides the advertisement(s) along with the content item for presentation to the user. In some implementations, the content sharing server streams the advertisement(s) and the content item to the media player on the user device. Alternatively, the content sharing server instructs the advertisement management server to stream the advertisement(s). That is, the advertisement(s) can be streamed from the advertisement management server, and the content item can be streamed from the content sharing server. The content sharing server can also instruct the media player to start presenting the content item once the playback of the advertisement(s) has been completed (e.g., when the playback reached the end of the advertisement(s) or when the playback of the advertisement(s) was rejected by a user via, e.g., a skip UI element).

When the advertisement management server provides multiple advertisements for the content item, a first advertisement in a list with a duration corresponding to the advertisement duration is selected. In another embodiment, other factors contribute to the selection of the advertisement, such as subject matter, advertiser preference, advertisement fees, etc.

According to an embodiment, the advertisement or a portion of the advertisement is displayed prior to display of the content. Further to the example above, Advertisement 1 and Content A are delivered for display on the user device, where Advertisement 1 is displayed prior to display of Content A.

FIG. 4A is a flow diagram illustrating an embodiment for a method 400 of obtaining advertisements for a content item. The method 400 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 400 is performed by a server (e.g., the content sharing server 110 of FIG. 1).

At block 402, processing logic sends an advertisement request for the content item to an advertisement management server, where the advertisement request includes characteristics of the content item. For example, a request can include an identifier of the requested content item, such as the content item's category (e.g., business, movies, music, etc.), content item type (e.g., video, audio, content item age, geo-location information), etc.

At block 404, processing logic receives from the advertisement management server, a plurality of advertisements corresponding to the characteristics of the content item. For example, the plurality of advertisements can correspond to the content item's category or the content item type. In one example, the content item type can indicate that the content is related to a particular region, so that the plurality of advertisements can relate to that particular region. In this example, a content item showing a sports team for Region A can be matched with a plurality of advertisements for businesses in Region A.

At block 406, processing logic selects the advertisement based on a duration correspondence criterion. According to an embodiment, the duration correspondence criterion can be used to determine the advertisement duration based on the content duration. In an example, a duration correspondence criterion can be that advertisement duration for content durations in a range between 25 minutes and 35 minutes is in a range between 90 seconds and 150 seconds. If the content duration of Content Z is 30 minutes, then an advertisement with an advertisement duration in a range between 90 seconds and 150 second can be selected.

According to an embodiment, an advertisement can also be selected based on bids associated with the plurality of advertisements, based on performance scores of the plurality of advertisements, or on a reservation basis.

According to an embodiment, advertisements can be selected where the sum of the durations of each advertisement corresponds to the advertising duration. According to another embodiment, advertisements are selected where the sum of the durations of the advertisements is in a range defined by the advertising duration. Further to the example above, Advertisement 7 has a duration of 45 seconds, Advertisement 8 has a duration of 45 seconds, and Advertisement 9 has a duration of 30 seconds. The sum of the duration of Advertisement 7, Advertisement 8, and Advertisement 9 is 120 seconds, which is within the range defined by the advertising duration determined for Content Z. Therefore, Advertisement 7, Advertisement 8, and Advertisement 9 can be selected to be displayed together along with Content Z.

FIG. 4B is a flow diagram illustrating an embodiment for a method 400 of providing one or more advertisements for a content item. The method 400 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 400 is performed by a server (e.g., the advertisement management server 102 of FIG. 1).

At block 452, processing logic receives an advertisement request for a content item from a content sharing server. For example, the advertisement request can be received in response to a request for a content item being received by the content sharing server.

At block 454, processing logic identifies characteristics of the content item and a duration of the content item. For example, the characteristics and the duration of the content item can be included in the advertisement request. In some implementations, the advertisement request may also include a duration correspondence criterion.

At block 456, processing logic selects one or more advertisements that correspond to the characteristics of the content item and have a duration commensurate with the duration of the content item. For example, one or more advertisements are selected using a duration correspondence criterion. In an example, the duration correspondence criterion can require that the duration of the advertisement be no longer than the duration of the content item or that the duration of the advertisement be a fraction of the duration of the content item. The duration correspondence criterion can be, for example, defined by an advertiser associated with the advertisement, set by the advertisement management server, provided in the advertisement request, etc. In some implementations, processing logic selects multiple advertisements, and the combined duration of the selected advertisements is commensurate with the duration of the content item (e.g., the combined duration satisfies the duration correspondence criterion).

At block 458, processing logic provides the selected advertisements for targeting the content item to the content sharing server.

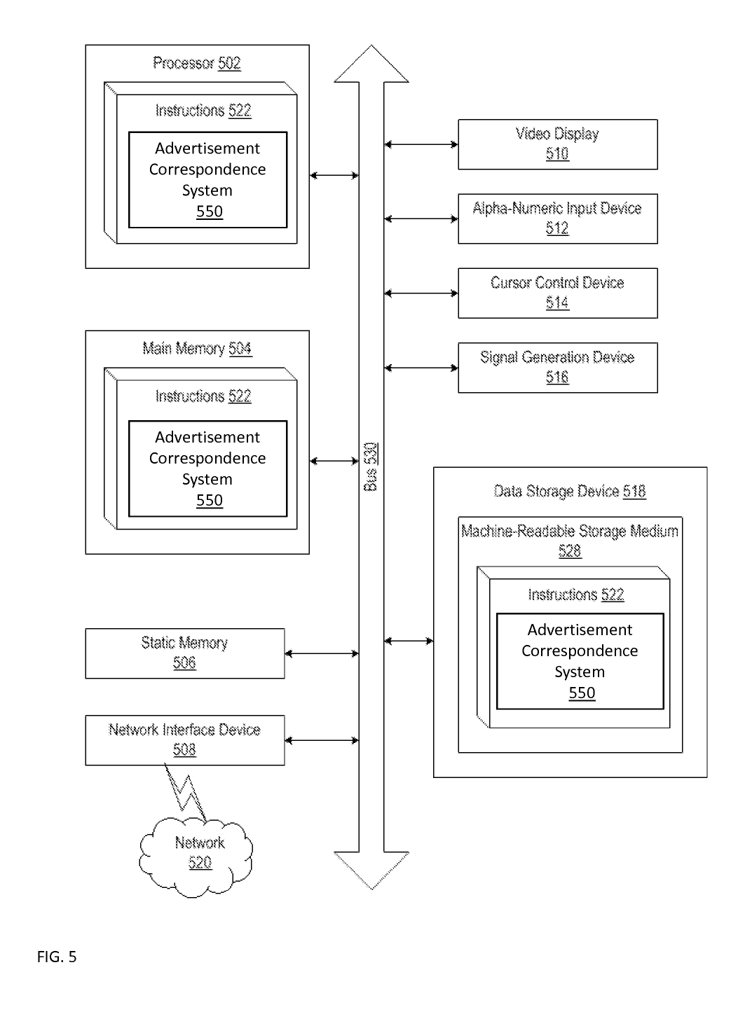

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device (processor) 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute instructions 522 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 518 may include a machine-readable storage medium 528 on which is stored one or more sets of instructions 522 (e.g., software) embodying any one or more of the methodologies or functions described herein. The instructions 522 may also reside, completely or at least partially, within the main memory 504 and/or within the processor 502 during execution thereof by the computer system 500, the main memory 504 and the processor 502 also constituting computer-readable storage media. The instructions 526 may further be transmitted or received over a network 516 via the network interface device 508.

In one embodiment, the instructions 522 include instructions for a advertisement correspondence system 550, which may correspond to advertisement correspondence system 135 of FIG. 1. While the machine-readable storage medium 528 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing, encoding or carrying a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A method, implemented by a server computing system, comprising:
receiving, by the server computing system, a user request for a content item;
identifying, by the server computing system, a duration of the content item;
accessing, by a processor of the server computing system, a duration correspondence criterion from a data store, the duration correspondence criterion comprising data indicating a proportion between an advertisement duration and a content duration;
determining, by the server computing system, a particular advertisement duration corresponding to the content item based on content of the content item, the duration of the content item, and the duration correspondence criterion;
obtaining, by the server computing system, at least one advertisement in view of the particular advertisement duration; and
providing, by the server computing system, the at least one advertisement along with the content item for presentation to the user.

2. The method of claim 1, wherein the at least one advertisement comprises a plurality of advertisements, and wherein a combined duration of the plurality of advertisements is commensurate with the duration of the content item.

3. The method of claim 1, wherein the duration of the content item is identified based on metadata associated with the content item.

4. The method of claim 1, wherein obtaining the advertisement further comprises:
sending an advertisement request to an advertisement management server, the advertisement request comprising characteristics of the content item;
receiving, from the advertisement management server, a plurality of advertisements corresponding to the characteristics of the content item; and
selecting the at least one advertisement from the plurality of advertisements based on the duration correspondence criterion.

5. The method of claim 4, wherein the duration correspondence criterion is defined by an owner of the content item or a content sharing service.

6. The method of claim 4, wherein the duration correspondence criterion causes the duration of the advertisement to be no longer than the duration of the content item.

7. (canceled)

8. The method of claim 1, wherein obtaining the advertisement further comprises:
sending an advertisement request to an advertisement management server, the advertisement request comprising characteristics of the content item and the duration of the content item; and
receiving, from the advertisement management server, the at least one advertisement satisfying the duration correspondence criterion.

9. The method of claim 8, wherein:
the duration correspondence criterion is defined by an advertiser associated with the advertisement; and
the advertisement satisfying the duration correspondence criterion is selected at the advertisement management server.

10. A method comprising:
receiving, by an advertisement management server, an advertisement request for a content item from a content sharing server;
identifying, based on the advertisement request, characteristics of the content item and a duration of the content item;
determining, by a processor of the advertisement management server, a particular advertisement duration available for one or more advertisements based on the duration of the content item and a duration correspondence criterion, the duration correspondence criterion comprising data indicating a proportion between an advertisement duration and a content duration, wherein the particular advertisement duration is equal to or greater than the duration of the content item;
selecting, from a data store, at least one advertisement based on the particular advertisement duration, the advertisement corresponding to the characteristics of the content item; and
providing, to the content sharing server, the selected advertisement for targeting the content item.

11. The method of claim 10, wherein the duration correspondence criterion further comprises data permitting the duration of the advertisement to be longer than the duration of the content item when the content item includes special content comprising news content.

12. The method of claim 10, wherein the duration correspondence criterion causes the duration of the advertisement to be no longer than the duration of the content item.

13. (canceled)

14. The method of claim 11, wherein the duration correspondence criterion is defined by an advertiser associated with the advertisement.

15. A non-transitory computer readable storage medium having instructions that, when executed by a processing device, cause the processing device to perform operations comprising:
receiving a user request for a content item;
identifying a duration of the content item;
accessing, by the processing device, a duration correspondence criterion from a data store, the duration correspondence criterion comprising data indicating a proportion between an advertisement duration and a content duration;
determining, by the processing device, a particular advertisement duration corresponding to the content item based on content of the content item, the duration of the content item, and the duration correspondence criterion;
obtaining at least one advertisement in view of the particular advertising duration; and
providing the at least one advertisement along with the content item for presentation to the user.

16. The non-transitory computer readable storage medium of claim 15, wherein the at least one advertisement comprises a plurality of advertisements, and wherein a combined duration of the plurality of advertisements is commensurate with the duration of the content item.

17. The non-transitory computer readable storage medium of claim 15, wherein the duration of the content item is identified based on metadata associated with the content item.

18. The non-transitory computer readable storage medium of claim 15, wherein obtaining the advertisement further comprises:
sending an advertisement request to an advertisement management server, the advertisement request comprising characteristics of the content item;
receiving, from the advertisement management server, a plurality of advertisements corresponding to the characteristics of the content item; and
selecting the at least one advertisement from the plurality of advertisements based on the duration correspondence criterion.

19. The non-transitory computer readable storage medium of claim 18, wherein the duration correspondence criterion is defined by an owner of the content item or a content sharing service.

20. The non-transitory computer readable storage medium of claim 18, wherein the duration correspondence criterion causes the duration of the advertisement to be no longer than the duration of the content item.

21. (canceled)

22. The non-transitory computer readable storage medium of claim 15, wherein obtaining the advertisement further comprises:
sending an advertisement request for the content item to an advertisement management server, the advertisement request comprising characteristics of the content item and the duration of the content item; and
receiving, from the advertisement management server, the advertisement satisfying the duration correspondence criterion.

23. The non-transitory computer readable storage medium of claim 22, wherein:
the duration correspondence criterion is defined by an advertiser associated with the advertisement; and
the advertisement satisfying the duration correspondence criterion is selected at the advertisement management server.

24. A computing device comprising:
a memory; and
a processing device coupled to the memory, wherein the processing device is configured to:
receive a user request for a content item;
identify a duration of the content item;
access a duration correspondence criterion from a data store, the duration correspondence criterion comprising data indicating a proportion between an advertisement duration and a content duration;
determine a particular advertisement duration corresponding to the content item based on content of the content item, the duration of the content item, and the duration correspondence criterion;
obtain at least one advertisement in view of the particular advertisement duration; and
provide the advertisement along with the content item for presentation to the user.

25. The computing device of claim 24, wherein the at least one advertisement comprises a plurality of advertisements, and wherein a combined duration of the plurality of advertisements is commensurate with the duration of the content item.
